(19) United States
(12) Patent Application Publication
(10) Pub. No.: US 2012/0243703 A1
(43) Pub. Date: Sep. 27, 2012

(54) Headphone structure

(76) Inventor: To-Teng Huang, Taoyuan City (TW)

(21) Appl. No.: 13/067,233

(22) Filed: May 18, 2011

(30) Foreign Application Priority Data
Mar. 21, 2011 (TW) 100204987

(51) Int. Cl. H04R 1/10

(52) U.S. Cl. 381/74

(57) ABSTRACT

A headphone structure includes a first earpiece, a second earpiece, a pair of conductive head strips, a signal input cable, and an electrical plug. The conductive head strips are each electrically connected between the first and the second earpieces, and are each coated externally with an insulation layer. The signal input cable includes a first end electrically connected to the first earpiece, and a second end electrically connected to the electrical plug. Thereby, the headphone structure not only has merits on being as a one-side cable-out headphone so as to avoid time-consuming cable embedment and wiring, but also on eliminating use of a plastic headband by instead using directly the conductive head strips as a headset.

### BACKGROUND OF THE INVENTION

1. Field of the Invention

The present invention relates to a headphone structure, and more particularly, to a headphone structure having a pair of conductive head strips.

2. Description of Related Art

Nowadays, there are many kinds of headphones available in the market, except for earphones and neck phones which are distinguished from the headphones in terms of modes of usage, wherein the headphones have merits on a more desirable fixity.

Referring to FIG. 1, a schematic view illustrating a type of conventional headphone, the headphone comprises two earpieces 80,81, a plastic headband 82, two signal input cables 83,84, and an electrical plug 85. The two earpieces 80,81 are physically connected through the plastic headband 82. The two signal input cables 83,84 correspond to the two earpieces 80,81, respectively. Namely, the two signal input cables 83,84 are electrically connected between the earpieces 80,81 and the electrical plug 85. Besides, the two signal input cables 83,84 are electrically connected, by bunching at their rear ends, with the electrical plug 85. This type of conventional headphone has a shortcoming that the signal input cables 83,84 are considered comparatively numerous such that they become an obstacle when wearing the headphone and are inconvenient for users.

Further referring to FIG. 2, a schematic view illustrating another type of conventional headphone, this type of headphone comprises two earpieces 90,91, a plastic headband 92, a signal transmission cable 93, a signal input cable 94, and an electrical plug 95. Likewise, the two earpieces 90,91 are physically connected with each other through the plastic headband 92. The signal transmission cable 93 is electrically connected between the two earpieces 90,91, and is electrically connected between one of the two earpieces 90 and the electrical plug 95. The conventional art has merits on that only the earpiece 90 is connected with the signal transmission cable 93 located opposite to the plastic headband 92, making it more convenient for headphone wearing.

Of course, it is well known that all the signal transmission cable 93 and the signal input cables 83,84,94 are related to a soft-cord structure. In other words, two conductive wires (so-called “twin-core wires”) are enveloped by a soft sleeve. As shown in FIG. 2, the signal transmission cable 93 is required to be embedded into the plastic headband 92. However, the embedment of cable is not only time consuming, but also increases design difficulties because wiring requires aesthetic appearance. Moreover, no mater which type of the conventional art, both types of the headphones require to use two soft cords for electrical conduction and a plastic headband.

### SUMMARY OF THE INVENTION

An object of the present invention is to provide a headphone structure so as to decrease the number of components being used and to avoid concern on complicated wiring.

To achieve the object, the headphone structure, according to the present invention, comprises a first earpiece, a second earpiece, a pair of conductive head strips, a signal input cable, and an electrical plug. The conductive head strips are each electrically connected between the first and the second earpieces, and are each coated externally with an insulation layer.

According to the present invention, the signal input cable includes a first end and a second end, wherein the former is electrically connected to the first earpiece, while the latter to the electrical plug.

Through such design of structure, as given above, it is understood that the headphone structure, according to the present invention, not only has merits on being as a one-side cable-out headphone so as to avoid the time-consuming cable embedment and wiring as required for the conventional art, but also on eliminating use of the plastic headband as for the conventional art, so that manufacturing cost thereof can be lowered down.

Further, according to the present invention, the first and the second earpieces may be designed to, but of course not limited to, be in electrically parallel connection. The earpieces each consists of a speaker unit and an earmuff, wherein the earmuffs wrap up and protect the speaker units. The two conductive head strips are each electrically connected between the two speaker units. The signal input cable has its first end electrically connected to the speaker unit of the first earpiece.

Still further, according to the present invention, the two conductive head strips may be connected with each other by plural insulating fixing ribs so as to maintain a proper spacing between the two conductive head strips such that a preferable position fixing effect can be obtained. The insulating fixing ribs are arranged, for example, in parallel or even crisscrossed from one another. The conductive head strips may be made of metallic material such as copper.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic view illustrating a type of conventional headphone;

FIG. 2 is a schematic view illustrating another type of conventional headphone;

FIG. 3 is a perspective view illustrating a headphone structure according to the present invention; and

FIG. 4 is a perspective cross-sectional view illustrating part of paired conductive head strips as show in FIG. 3.

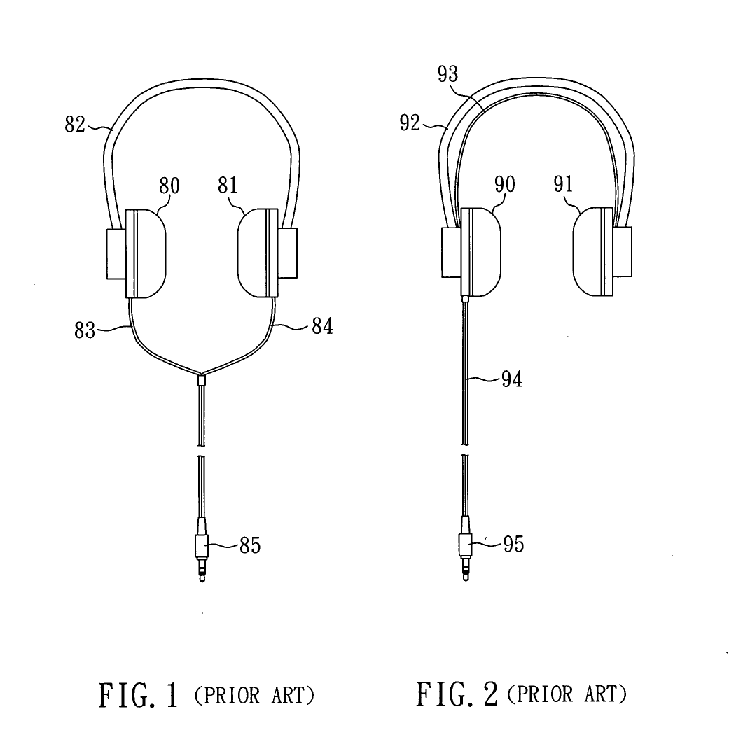

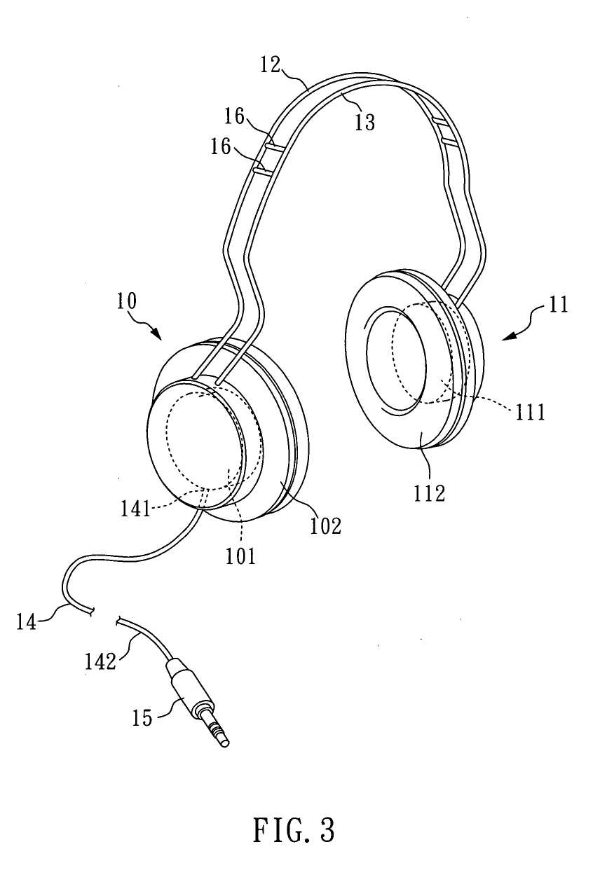

### DETAILED DESCRIPTION OF THE PREFERRED EMBODIMENTS

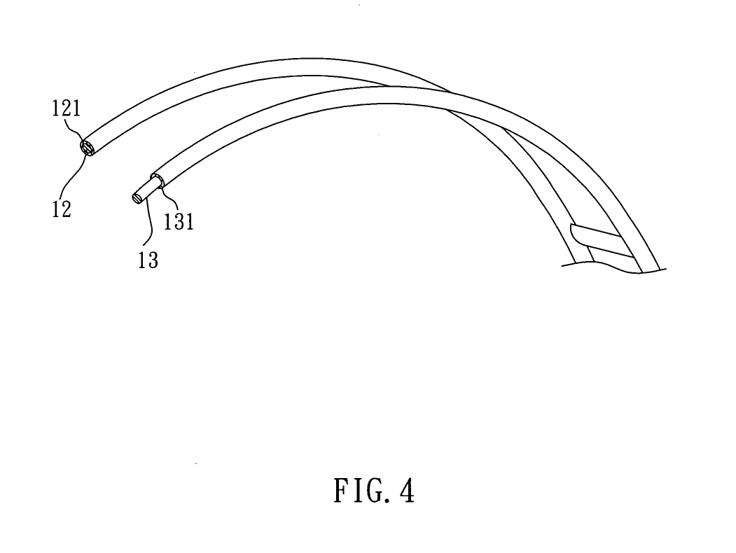

Referring to FIG. 3, a perspective view illustrating a headphone structure according to the present invention, and to FIG. 4, a perspective cross-sectional view illustrating part of paired conductive head strips as shown in FIG. 3, the headphone structure comprises a first earpiece 10, a second earpiece 11, a pair of conductive head strips 12,13, a signal input cable 14, and an electrical plug 15. The earpieces 10,11 each consists of a speaker unit 101,111 and an earmuff 102, 112, wherein the earmuffs 102, 112 wrap up the speaker units 101, 111. The conductive head strips 12,13 are made of, for example, metallic material, preferably copper; and that the earmuffs 102,112 are of plastic material.

Further, according to the present embodiment, the signal input cable 14 relates to a twin-core soft wire, wherein its first end 141 is electrically connected to the speaker unit 101 of the first earpiece 10, while its second end 142 to the electrical plug 15. Audio signal from outside is transmitted to the speaker units 101,111 through the electrical plug 15 and the signal input cable 14.

According to the present embodiment, the first earpiece 10 is to be worn at a user's left ear; and the second earpiece 11 at the user's right ear. Of course, the first earpiece 10 can alternatively be designed to be worn at the user's right ear; while the second earpiece 11 at the user's left ear.

The conductive head strip 12 is formed as an arch shape, wherein its two ends pass through the earmuff 102 of the first earpiece 10 and the earmuff 112 of the second earpiece 11, respectively, and are physically and electrically connected to the two speaker units 101,111. Likewise, the other conductive head strip 13 also has its two ends physically and electrically connected to the two speaker units 101,111. Through such arrangement, the two earpieces 10,11 are in electrically parallel connection. Further, the two conductive head strips 12,13 are coated externally with insulation treatment such that each is formed with an insulation layer 121,131.

Given the above, it is understood that the headphone structure, according to the present invention, provides a one-side cable-out headphone, wherein the two conductive head strips 12,13 not only serve to transmit signals between the two earpieces 10,11, but also function as a headset. As a result, components are saved as compared with the conventional art. Moreover, the time-consuming cable embedment and the wiring for aesthetic appearance, as required for the conventional art, are found unnecessary in the present invention. Therefore, the present invention has a great predominance on manufacturing cost saving.

Further, as shown in FIGS. 3 and 4, the two conductive head strips 12,13 can be connected with each other by plural insulating fixing ribs 16 which are arranged, for example, in parallel, nonparallel, or even crisscrossed from one another. The insulating fixing ribs 16 not only have a function of formation and position fixing, but also serve to prevent the two conductive head strips 12,13 from short circuit.

Although the present invention has been explained in relation to its preferred embodiments, it is to be understood that many other possible modifications and variations can be made without departing from the scope of the invention as hereinafter claimed.

What is claimed is:

1. A headphone structure, comprising:
a first earpiece;
a second earpiece;
a pair of conductive head strips, each being electrically connected between the first and the second earpieces, and each being coated externally with an insulation layer;
a signal input cable, including a first end and a second end, wherein the former is electrically connected to the first earpiece; and
an electrical plug, being electrically connected to the second end of the signal input cable.

2. The headphone structure as claimed in claim 1, wherein the first and the second earpieces are in electrically parallel connection.

3. The headphone structure as claimed in claim 1, wherein the paired conductive head strips are connected with each other by plural insulating fixing ribs.

4. The headphone structure as claimed in claim 3, wherein the plural insulating fixing ribs are arranged in parallel from one another.

5. The headphone structure as claimed in claim 1, wherein the conductive head strips are made of copper.

6. The headphone structure as claimed in claim 1, wherein the earpieces each consists of a speaker unit and an earmuff, wherein the earmuffs wrap up and protect the speaker units; and wherein the paired conductive head strips are each electrically connected between the speaker units, and the first end of the signal input cable is electrically connected to the speaker unit of the first earpiece.
